(19) United States
(12) Patent Application Publication
(10) Pub. No.: US 2008/0219360 A1
(43) Pub. Date: Sep. 11, 2008

(54) SYSTEM AND METHOD FOR PERFORMING CHANNEL ESTIMATION USING INTERPOLATION

(75) Inventors: RALK HEKMANN, CHICAGO, IL (US); ROBERT J. CORKE, GLEN ELLYN, IL (US); DANIEL G. PRYSBY, SLEEPY HOLLOW, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/682,959

(22) Filed: Mar. 7, 2007

(51) Int. Cl. H04K 1/10

(52) U.S. Cl. 375/260

(57) ABSTRACT

A system and method for performing channel estimation. The system includes a receiver for decoding OFDM. Upon receiving an OFDM symbol, a plurality of demodulated subcarrier modulation symbols for the OFDM symbol are generated. The demodulated subcarrier modulation symbols are then decoded to generate decoder output code symbols. At least a portion of the decoder output code symbols are reencoded, interleaved, and mapped to a set of reference symbols, where the set of reference symbols correspond to at least a portion of the plurality of subcarriers. A first set of channel estimates is generated, based on at least a portion of the set of reference symbols and a corresponding portion of the plurality of demodulated symbols. Remaining channel estimates are then interpolated from the first set of estimates by filtering the first set of estimates. The channel estimates are then used in decoding a current OFDM symbol being received by the receiver.

### TECHNICAL FIELD OF THE DISCLOSURE

This disclosure relates generally to decision directed channel estimation in a receiver, and more particularly, to a system and method for performing channel estimation using interpolation.

### BACKGROUND OF THE DISCLOSURE

Pilot symbol aided Minimum Mean-Squared Error (MMSE) channel estimation (which uses pre-determined or known symbols, commonly referred to in the art as pilot and preamble symbols, in deriving channel estimates) is a well-known method of obtaining channel gain information for symbol decoding in single or multi-carrier systems. For example, the pilot symbol aided MMSE channel estimation method is used in Orthogonal Frequency Division Multiplexing (OFDM) systems such as those that operate in accordance with the Institute of Electrical and Electronics Engineers (IEEE) 802.11a and 802.11g standards.

In some systems, pilot symbol placement and density is designed to enable adequate pilot symbol aided MMSE channel estimation only for low speed applications, for example applications at pedestrian speeds. However, when such systems are operated at higher speeds, a strictly pilot symbol aided channel estimation methodology often proves inadequate. To improve channel estimation for such systems at higher speeds, a decision directed MMSE channel estimation approach may be used. This decision directed approach is also referred to herein as reference symbol aided channel estimation to cover the potential use of both pre-determined as well as regenerated symbols in the channel estimation process.

To implement the reference symbol aided channel estimation approach using pilot and regenerated symbols, a receiver in an OFDM system generally includes a MMSE predictive channel estimator to extrapolate the channel gain at a given data symbol location or instant. The channel estimator generally produces smoothed or predicted channel estimates from a set of “raw” or instantaneous estimates typically at nearby (in the time or frequency sense) symbols. The estimator combines these raw channel estimates weighted by appropriate filter coefficients to predict the channel estimate for the given data symbol.

More particularly, when a radio frequency (RF) signal corresponding to an OFDM symbol is received, the receiver demodulates the OFDM symbol to generate a set of demodulated output symbols, with one demodulated output symbol corresponding to each of a plurality of data subcarriers comprising the OFDM symbol. Each demodulated symbol is then deinterleaved and decoded. The decoded symbols are reencoded, interleaved, and mapped to a set of reference symbols. In general, each of the reference symbols corresponds to a complex symbol in the set of demodulated symbol outputs K OFDM symbols ago, where K is indicative of a delay due to deinterleaving, decoding, and symbol regeneration delays. The reference symbols, along with delayed demodulated symbols, which are delayed by K OFDM symbols so that they are time-aligned with corresponding regenerated symbols, are provided to a channel estimator, which then generates the new channel estimates.

Thus, the performance of the channel estimator, and hence the receiver, depends heavily on the delay, measured in OFDM symbols, associated with the decoding and regeneration of the received OFDM symbols. This is particularly true in higher speed applications. In general, the shorter the delay in generating channel estimates for an OFDM, the more accurate the channel estimate. Thus, any increase in the delay associated with symbol regeneration and the resulting channel estimation will reduce the relevance of the channel estimation relative to the time that it is used.

As an example, let us assume that a receiver operates in accordance with the IEEE 802.11a or 802.11g standard. For all coding rates and Quadrature Amplitude Modulation (QAM) constellations, an interleaver within the receiver typically spans exactly one OFDM symbol, and requires as input the quantity of code symbols contained in an entire OFDM symbol. As a result, the interleaver introduces a single OFDM symbol of delay. The decoder induced delay depends on the traceback length of the decoder, which is typically at least five times the constraint length of the code utilized by the decoder, where the constraint length of the code is taken as one more than log 2 of the number of decoder states. For example, the constraint length of a convolutional code used in 802.11a and 802.11g standards is 7, so the traceback length of the decoder is typically chosen to be at least 35 information bits. Given such a decoder traceback length, the channel estimator for conventional receivers operating in accordance with the 802.11a or 802.11g standards will typically have an overall delay of two or three OFDM symbols (i.e., the channel estimator includes a K-step predictor with K=2 or 3 OFDM symbols) depending on the modulation type and code rate used.

One exemplary method for reducing the overall delay in signal decoding and regeneration has been described in U.S. patent application Ser. No. 11/108,291, by Frank et al, which is incorporated by reference herein. In particular, Frank et al. describes a system and method in which interleaving, QAM mapping, and channel estimation can be performed with reference to only a portion of the OFDM symbol. Thus, generation of reference symbols can be configured to begin before all of the reencoded code symbols are available, and new channel estimates may be generated before all of the reference symbols are available. As a result, the disclosure of Frank et al. provides a system and method in which the overall delay for the channel estimator can be decreased by at least one OFDM symbol.

### BRIEF DESCRIPTION OF THE FIGURES

Various embodiment of the disclosure are now described, by way of example only, with reference to the accompanying figures.

FIG. 1 shows one embodiment of a receiver in accordance with the present disclosure.

FIG. 2 shows one embodiment of a channel estimator in accordance with the present disclosure.

FIG. 3 shows one embodiment of a method for performing channel estimation in accordance with the present disclosure.

FIG. 4 shows a timing diagram for channel estimation in the receiver of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

The present disclosure provides a system and method for performing channel estimation. The system includes a receiver for decoding OFDM. Upon receiving an OFDM symbol, a plurality of demodulated subcarrier modulation symbols for the OFDM symbol are generated. This plurality of demodulated symbols include a demodulated symbol corresponding to each subcarrier of the OFDM symbol. The demodulated symbols are then decoded to generate decoder output code symbols. At least a portion of the decoder output code symbols are reencoded, interleaved, and mapped to a set of reference symbols, where the set of reference symbols correspond to at least a portion of the plurality of subcarriers.

In accordance with the present disclosure, a first set of channel estimates is generated, based on at least a portion of the set of reference symbols and a corresponding portion of the plurality of demodulated symbols. Remaining channel estimates are then interpolated from the first set of estimates by, for example, filtering the first set of estimates. The channel estimates are then used in decoding a current OFDM symbol being received by the receiver. Thus, the present disclosure provides yet another system and method for providing additional reduction in channel estimation delays that may be used in conjunction with either the disclosure of Frank et al. or with conventional channel estimation techniques.

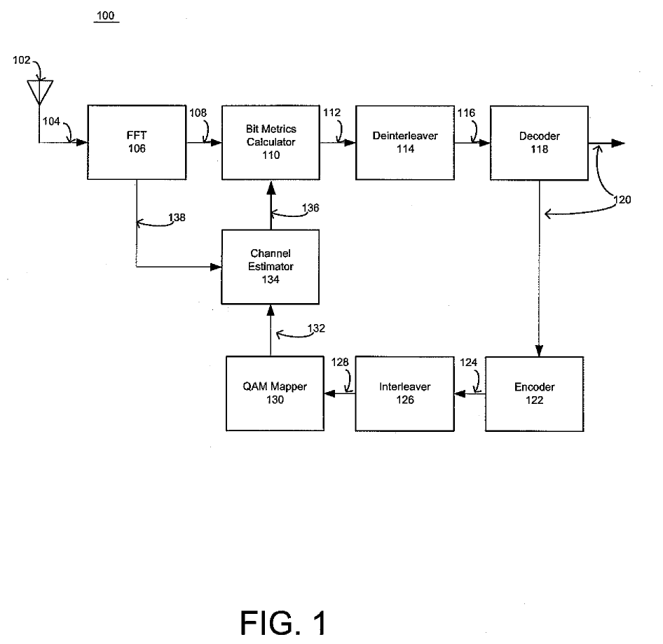

Let us now discuss the present disclosure in greater detail by referring to the figures below. FIG. 1 illustrates one exemplary embodiment of a receiver 100 according to the present disclosure. In order to show a practical example of the present disclosure, the receiver 100 is illustrated using a QAM modulation technique. However, it should be understood that this illustration is not meant to limit the present disclosure to this particular modulation technique, and it is contemplated that various other embodiments of the present disclosure may be implemented using other types of modulation techniques (e.g. Binary Phase Shift Keying (BPSK) and Phase Shift Keying (PSK))

As shown in FIG. 1, the receiver 100 may include one or more antenna elements 102, a demodulator 106 (for example, one that implements a Fast Fourier Transform (FFT) operation), a bit metrics calculator 110, a deinterleaver 114, a decoder 118 (for example, a Viterbi Decoder), an encoder 122 (for example, a convolutional encoder), an interleaver 126, a QAM mapper 130, and a channel estimator 134. The receiver may also include suitable circuitry between the antenna elements 102 and the demodulator 106 for performing all required filtering and down-conversion operations needed to obtain a time-domain digital baseband signal. However, such circuitry is not illustrated for the sake of clarity in describing the present disclosure.

In operation, a RF signal (for instance corresponding to an OFDM symbol) is received by antenna element 102, which is converted to a digital baseband signal 104. Signal 104 is processed by the demodulator 106 to generate a set of demodulated complex symbols 108 (also referred to herein as demodulated symbols). The set of demodulated symbols 108 typically includes one demodulated symbol corresponding to each of a plurality of subcarriers that comprise the OFDM symbol. Each complex demodulated symbol 108 and a corresponding channel estimate 136 from the channel estimator 134 is fed into the bit metric calculator 110 to produce binary code symbol metrics 112 (ideally soft bit metrics).

The binary code symbol metrics 112 are deinterleaved by the deinterleaver 114 to produce deinterleaved code symbol metrics 116. The deinterleaved code symbol metrics 116 are provided to the decoder 118 which generates output code symbols 120. The output code symbols 120 are reencoded by the encoder 122 to produce reencoded code symbols 124, which are then interleaved by the interleaver 126 to generate interleaved binary code symbols 128. The binary code symbols 128 are then mapped via QAM mapper 130 to QAM reference symbols 132.

In one exemplary embodiment, the interleaver 126 and the QAM mapper 130 may be configured to operate in accordance with the disclosure of the aforementioned U.S. patent application Ser. No. 11/108,291. That is, the interleaver 126 and QAM mapper 130 may be configured to operate as soon as the required inputs are available. Thus, generation of interleaved code symbols may begin as soon as sufficient reencoded code symbols are made available, and reference symbols may be generated as soon as sufficient interleaved code symbols are available. Of course, it is understood that the interleaver 126 and the QAM mapper 130 may also be configured using conventional techniques whereby generation of reference symbols is not performed until all of the reencoded code symbols for an OFDM symbol are available.

The reference symbols 132 generated by the QAM mapper 130 are sent to the channel estimator 130. In accordance with the present disclosure, the channel estimator 134 is configured to use the reference symbols 132, or a portion thereof, to estimate a first portion of the channel and then use interpolation techniques to obtain the remaining channel estimates.

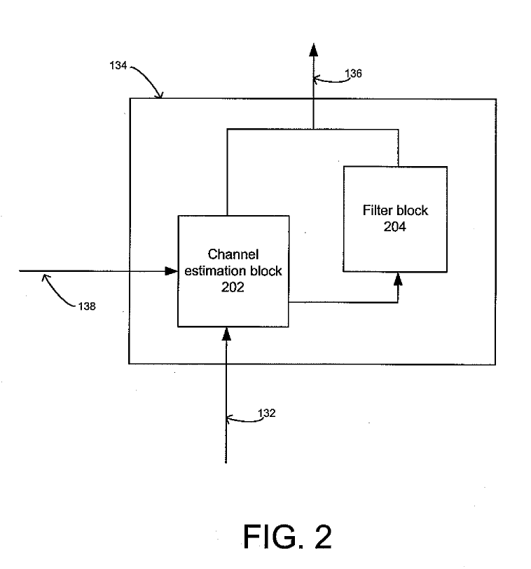

More particularly, as shown in FIG. 2, the channel estimator 134 comprises a channel estimation block 202 and a filter block 204. Each reference symbol 132 output by the QAM mapper 130 is fed to the channel estimation block 202 and corresponds to a complex symbol in the set of demodulated symbol outputs 108 from the demodulator 106 K OFDM symbols ago, due to deinterleaving, decoding, and symbol regeneration delays. A delayed demodulated symbol 138 is also provided from demodulator 106 to the channel estimation block 202, where the delayed demodulated symbol 138 has a K OFDM symbol delay so that it is time-aligned with the corresponding reference symbol 132. In the channel estimation block 202, a delayed demodulated symbol 138 is scaled by the inverse of a corresponding reference symbol 132 to produce a raw channel gain estimate from K OFDM symbols ago. The raw channel gain estimates for a portion of the subcarriers is then filtered by channel estimation filter coefficients to produce channel estimates 136 for at least a portion of the subcarriers comprising the current OFDM symbol.

Once a sufficient number of channel estimates 136 are available, the filter block 204 determines any remaining channel estimates for the OFDM symbol by interpolating between the channel estimates 136 from the channel estimator 134. In one embodiment, the filter block 204 may use filtering of frequency domain estimates to perform the interpolation process, although any type of interpolation scheme may also be used.

The channel estimates 136 (both those determined by the channel estimation block 20 and those determined by the filter block 204) are sent to the bit metrics calculator 110 for use in decoding a current OFDM symbol. For purposes of this disclosure, channel estimates generated by the channel estimator will also be referred to as “calculated channel estimates” and channel estimates obtained by using interpolation techniques in the filter 138 will be referred to as “interpolated channel estimates.”

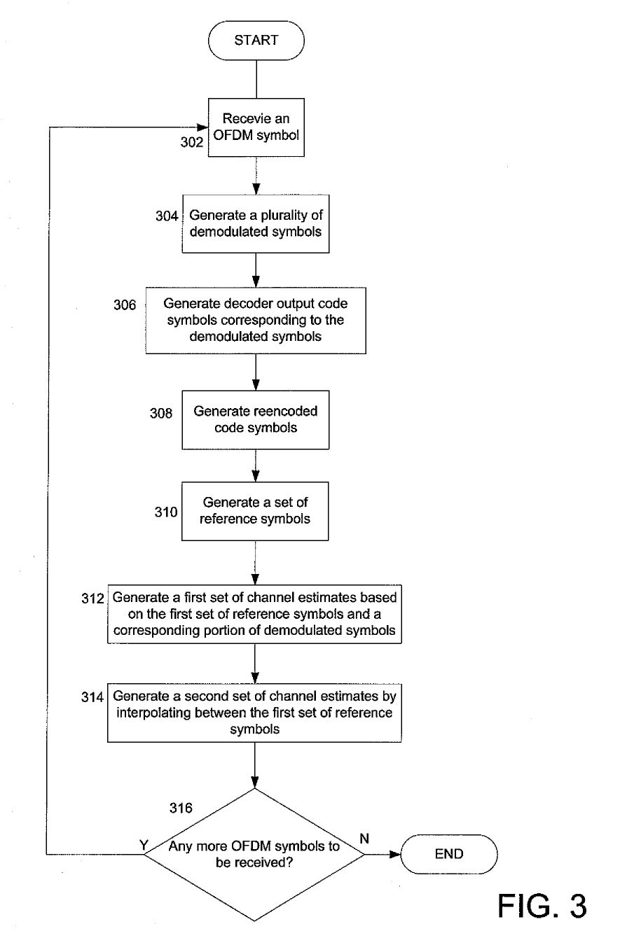

Turning to FIG. 3, one exemplary method for performing channel estimation in accordance with the present disclosure is illustrated. In step 302, the receiver 100 receives an OFDM symbol at the antenna(s) 102. A plurality of demodulated symbols 108 are generated in step 304, where the plurality of demodulated symbols includes one demodulated symbol for each subcarrier over which the OFDM symbol was transmitted. The decoder 118 operates on a first sequence of deinterleaved binary symbol metrics 118 to generate output code symbols 120 in step 306, and reencoded code symbols 126 are generated by the encoder 122 at step 308.

In step 310, a set of reference symbols 132 corresponding to at least a portion of the plurality of subcarriers are generated. If interleaver 126 and QAM mapper 130 are configured in accordance with the disclosure of U.S. patent application Ser. No. 11/108,291, the reference symbols 132 may be generated as soon as a predetermined number of QAM symbols for a particular subcarrier or subcarriers are defined, and thus a set of reference symbols 132 may correspond to a subset of the plurality of subcarriers. On the other hand, if interleaver 126 and QAM mapper 130 are configured in accordance with conventional techniques, the reference symbols 132 may not be generated until all of the QAM symbols for each subcarrier have been defined. In this instance, the set of reference symbols 132 generated in step 310 may include a reference symbol corresponding to each one of the plurality of subcarriers.

In step 312, the channel estimation block 302 of the channel estimator 134 generates calculated channel estimates 136 corresponding to a portion of the subcarriers on which the OFDM symbols was transmitted. As discussed above, the calculated channel estimates are determined based on the set of reference symbols 132 from step 310, and their corresponding time delayed demodulated symbols 142. As with the interleaver 326, the channel estimation block 202 may be configured to generate channel estimates as soon as any reference symbols is available, or upon a predetermined number of reference symbols being available.

Once sufficient calculated channel estimates are available, the filter block 304 begins generating interpolated channel estimates based on the set of calculated channel estimates in step 314. Whether sufficient calculated channel estimates are available may depend on the interleaving scheme used by the receiver 100 and/or a predetermined maximum number of channel estimates that may be interpolated between calculated channel estimates. Once channel estimates for each subcarrier have been generated, the process may return to step 302 if more OFDM symbols are to be received.

To best illustrate the steps described above, and in particular steps 310, 312 and 314, let us assume, for example, that the receiver 200 is configured to use an interleaving scheme in accordance with the IEEE 802.11a/g standard. As would be well understood by one skilled in the art, the order in which binary code symbols 128, and thus reference symbols 132 and channel estimates, are generated is generally fixed by the interleaving scheme used in a particular system. Particularly, in accordance with IEEE 802.11a/g standards, the order in which binary code symbols 128 are generated by the interleaver 124 initially enables a first group of reference symbols to be generated by the QAM mapper for every third subcarrier beginning with the first (e.g. 1, 4, 7, 10 . . . ). Once these reference symbols are generated, a second group reference symbols may be generated for every third subcarrier beginning with the second (e.g. 2, 5, 8, 11 . . . ) followed by a third group of reference symbols for each third subcarrier beginning with the third (e.g. 3, 6, 9, 12 . . . ).

In accordance with the present disclosure, the channel estimation block 202 generates calculated channel estimates based on the first group of reference symbols, thereby providing calculated channel estimates for one third of all the subcarriers. Of course, the channel estimation block 202 need not wait for the entire first group of reference symbols to be available, but may begin generating channel estimates based on each reference symbol 132 as soon as it is available. The filter block 204 may then be used to interpolate the channel estimates for each of the remaining subcarriers from the calculated channel estimates. Thus, in this example, the remaining two-thirds of the channel estimates may be obtained by the filter block 204 using interpolation techniques.

In the exemplary embodiment described above, the filter block 204 may also be configured to perform interpolation as soon as any two calculated channel estimates, which are three subcarrier spacings apart, are available. For example, the filter block 204 may be configured to interpolate channel estimates for subcarriers 2 and 3 as soon as channel estimates for subcarriers 1 and 4 have been calculated by the channel estimation block 202, to interpolate channel estimates for subcarriers 5 and 6 as soon as channel estimates for subcarriers 4 and 7 are available, and so on. Alternatively, the filter block 204 can be configured to perform interpolation only once a predetermined number of calculated channel estimates are available, where the predetermined number may include any subset or the entirety of the first group of reference symbols (1, 4, 7, 10 . . . ). In this instance, it should also be understood that the filter block 204 can also be configured to interpolate channel estimates from the set of calculated channel estimates in any desired order.

Of course, it should be understood that although the present disclosure has been described above in relation to one exemplary interleaving scheme, the present disclosure may also be used with other interleaving schemes. Thus, it is envisioned that an interleaving scheme may enable reference symbols to be first generated for a group consisting of every nth subcarrier (e.g. 1, 5, 9, 13 . . . ), where n can be any integer 2 or greater. In these instances, the channel estimation block 202 may provide channel estimates for every nth subcarrier, and the filter block may then be configured to generate interpolated channel estimates for the remaining subcarrier. However, if it is not desirable to interpolate between every nth subcarrier in such a system (for example, if the calculated channel estimates for every nth subcarrier are too far apart in frequency to enable accurate interpolation), the filter block 204 may also be configured to wait until additional channel estimates have been generated and the interval between calculated channel estimates is decreased to a predetermined amount.

Generally, the number of channel estimates that can be interpolated between calculated channel estimates is determined based on the correlation bandwidth of a given system. For example, assume an exemplary system in which a worst case (i.e., minimum) rms spread is 250 ns and the subcarrier spacing is 78 kHz. As would be understood by one skilled in the art, the correlation bandwidth for 50% frequency correlation may then be determined using the formula:

$$B = \frac{1}{2 πσ}$$

where B is the correlation bandwidth and σ is the worst-case (or minimum) rms delay spread. Thus, in this case, the correlation bandwidth is 667 kHz. Dividing 667 kHz/78 kHz yields 8.55. As such, interpolation may be used to obtain channel estimates between calculated channel estimates up to 8 subcarriers apart without significant error. Of course, depending on the amount of error that can be tolerated, it is understood that interpolation may be performed even if the calculated channel estimates are outside the correlation bandwidth.

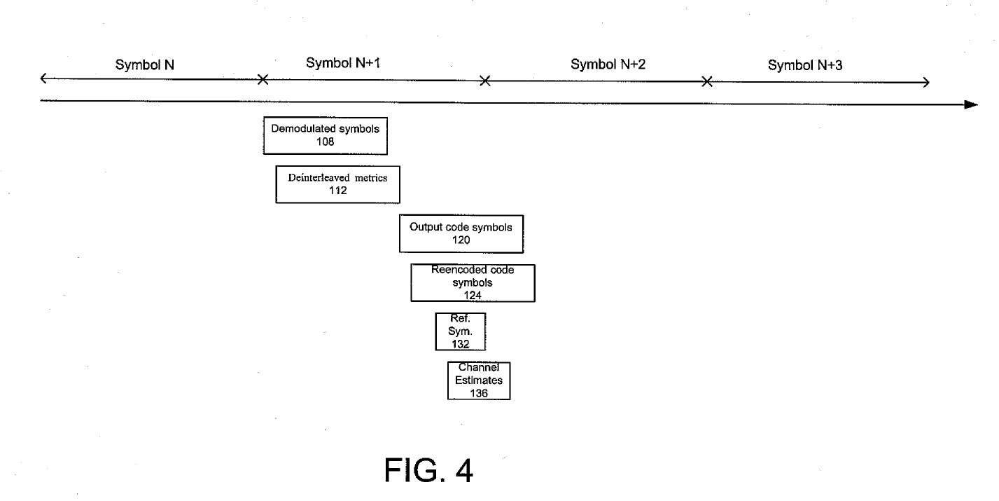

FIG. 4 shows a timing diagram illustrating the reduced channel estimation due to method 300. It should of course be understood that FIG. 4 is not meant to represent the precise timing of the receiver 300, but is merely provided as a means of understanding the advantages of the present disclosure as compared to previous methods used for channel estimation. To best illustrate the advantages of the present disclosure, the timing diagram in FIG. 4 also assumes that the interleaver 326 and QAM mapper 330 are configured to operate as soon as the appropriate inputs are available, as described in the disclosure of U.S. patent application Ser. No. 11/108,291.

As shown in FIG. 4, OFDM symbols are received at times n, n+1, n+2, and n+3. At time n+1, the demodulated symbols 108 and deinterleaved metrics 112 are generated for the OFDM symbol received at time n. Output code symbols 120 from the decoder 118 begin to be generated at time n+1 once all the deinterleaved metrics 112 are available. However, due to the traceback delay of the decoder 118, only a portion of the output code symbols 120 are generated at time n+1, and the remainder are generated at time n+2. Reencoded code symbols 124 from the encoder 122 also begin to be generated at time n+1 shortly after the output code symbols become available.

Since the QAM mapper 144 does not have to wait to generate reference symbols 132 until reencoded code symbols 124 are released and interleaved for all of the demodulated symbols, symbol regeneration can also begin at time n+1 for the OFDM symbol received at time n for some of the subcarriers.

Thus, as shown in FIG. 4, a first group of reference symbols 132 (for example, corresponding to every third subcarrier in an IEEE 802.11a/g system) can be generated during time n+1, and new channel estimates 136 (both calculated by the channel estimator and interpolated by the filter) may also begin to be generated during time n+1. Since interpolation is generally a faster process than the conventional process for estimating a channel, the entire set of channel estimates for an OFDM symbol can be obtained faster using the present disclosure than with traditional methods. In fact, as can be seen in FIG. 4, depending on the specific interleaving scheme, the present disclosure may permit channel estimates for all the subcarriers to be generated even before all of the OFDM symbol received at time n has been decoded.

Further advantages and modifications of the above described system and method will readily occur to those skilled in the art. Although a receiver using a QAM modulation scheme in accordance with IEEE 802.11a/g standards has been described, it is understood that the present disclosure may also be used with other modulation schemes and other standards. It should therefore also be understood that the timing illustrated in FIG. 4 may also be altered based on the modulation scheme and standard that is used. For example, if the receiver is configured to use a ½ rate BPSK modulation scheme, the delay in channel estimate generation may be increased by one OFDM symbol.

The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for channel estimation for use in decoding a current Orthogonal Frequency Division Multiplexing (OFDM) symbol, the method comprising:
receiving a first OFDM symbol over a plurality of OFDM subcarriers;
generating a plurality of demodulated symbols for the first OFDM symbol comprising a demodulated symbol corresponding to each subcarrier;
generating a set of decoder output code symbols from the plurality of demodulated symbols;
generating a set of reference symbols corresponding to at least a portion of the plurality of subcarriers;
generating a first set of channel estimates based on at least a portion of the set of reference symbols and a corresponding portion of the plurality of demodulated symbols; and
interpolating a second set of channel estimates from the first set of channel estimates,
wherein the first and second set of channel estimates are used in decoding the current OFDM symbol.

2. The method of claim 1 wherein each of the first set of channel estimates includes channel estimates corresponding to a first portion of the plurality of subcarriers for the first OFDM symbol, and the second set of channel estimates includes channel estimates corresponding to the remaining portion of the plurality of subcarriers for the first OFDM symbol.

3. The method of claim 1 wherein the method is implemented in a receiver operated in accordance with one of the Institute of Electrical and Electronics engineers 802.11a and 802.11g standards.

4. The method of claim 3 wherein the first set of channel estimates comprises channel estimates for one third of the subcarriers for the first OFDM symbol.

5. The method of claim 4 wherein the first set of channel estimates comprises channel estimates for every third one of the subcarriers for the first OFDM symbol.

6. The method of claim 5 wherein the first set of channel estimates comprises channel estimates for every n^{th} one of the subcarriers for the first OFDM symbol, where n is an integer.

7. The method of claim 1 wherein the second set of channel estimates is interpolated using filtering in the frequency domain of the first set of channel estimates.

8. A receiver comprising:
at least one antenna element for receiving a signal comprising OFDM symbols transmitted over a plurality of OFDM subcarriers;
a demodulator for generating a plurality of demodulated symbols for a first OFDM symbol, the plurality of demodulated symbols comprising a demodulated symbol corresponding to each subcarrier;
a decoder for generating a set of decoder output code symbols from the plurality of demodulated symbols;
a reference symbol mapper for generating a set of reference symbols corresponding to at least a portion of the plurality of subcarriers; and
a channel estimator configured to generate a first set of channel estimates based on at least a portion of the set of reference symbols and a corresponding portion of the plurality of demodulated symbols, and interpolate a second set of channel estimates from the first set of channel estimates,
wherein the first and second set of channel estimates are used in decoding the current OFDM symbol.

9. The receiver of claim 8 wherein each of the first set of channel estimates includes channel estimates corresponding to a first portion of the plurality of subcarriers for the first OFDM symbol, and the second set of channel estimates includes channel estimates corresponding to the remaining portion of the plurality of subcarriers for the first OFDM symbol.

10. The receiver of claim 8 wherein the receiver is configured to operate in accordance with one of one of the Institute of Electrical and Electronics Engineers (IEEE) 802.11a and 802.11g standards.

11. The receiver of claim 10 wherein the first set of channel estimates comprises channel estimates for one third of the subcarriers for the first OFDM symbol.

12. The receiver of claim 11 wherein the first set of channel estimates comprises channel estimates for every third one of the subcarriers for the first OFDM symbol.

13. The receiver of claim 8 wherein the first set of channel estimates comprises channel estimates for every n^{th} one of the subcarriers for the first OFDM symbol, where n is an integer.

14. The receiver of claim 8 wherein the demodulator implements a Fast Fourier Transform operation.

15. The receiver of claim 8 wherein the decoder is a Viterbi decoder.

16. The receiver of claim 8 wherein the channel estimator is comprised of a channel estimation block for generating the first set of channel estimates and a filter block for interpolating the second set of channel estimates.

17. The receiver of claim 16 wherein the filter block is configured to interpolate the second set of channel estimates using filtering in the frequency domain of the first set of channel estimates.

18. A method for channel estimation for use in decoding a current Orthogonal Frequency Division Multiplexing (OFDM) symbol, the method comprising:
means for receiving a first OFDM symbol over a plurality of OFDM subcarriers;
means for generating a plurality of demodulated symbols for the first OFDM symbol comprising a demodulated symbol corresponding to each subcarrier;
means for generating a set of decoder output code symbols from the plurality of demodulated symbols;
means for generating a set of reference symbols corresponding to at least a portion of the plurality of subcarriers;
means for generating a first set of channel estimates based on at least a portion of the set of reference symbols and a corresponding portion of the plurality of demodulated symbols; and
means for interpolating a second set of channel estimates from the first set of channel estimates,
wherein the first and second set of channel estimates are used in decoding the current OFDM symbol.
